(19) United States
(12) Patent Application Publication
(10) Pub. No.: US 2015/0193432 A1
(43) Pub. Date: Jul. 9, 2015

(54) SYSTEM FOR LANGUAGE TRANSLATION

(71) Applicant: Daniel Beckett, Fort Wayne, IL (US)

(72) Inventor: Daniel Beckett, Fort Wayne, IL (US)

(21) Appl. No.: 14/146,910

(22) Filed: Jan. 3, 2014

(51) Int. Cl. G06F 17/28

(52) U.S. Cl. CPC G06F 17/289

(57) ABSTRACT

A system of language translation compromising: a personal electronic device; memory residing on the personal electronic device; a microprocessor residing on the personal electronic device; a microphone on the personal electronic device to receive audio speech; a speaker on the personal electronic device to transmit audio speech; and software residing in the memory, where the software enables recognition of speech received in the microphone in a first language, and enables the transmission of a second language through the audio speakers, where the second language reflects a translation of the first language message received in the microphone.

### BACKGROUND OF THE INVENTION

1. Field of Invention

The present invention relates to a system that utilizes a personal electronic device to enable language translation.

2. Description of Related Art

Many individuals require or need foreign language translation especially when traveling abroad in a foreign country. Presently the options for language translation are limited. Some applications are available that allow individuals to input text or speech into a computer and have software on the computer translate the text or speech into a foreign language. Further general translation services are available but most require the use of a third party. Further guides or small instructional books and applications may be available that allow an individual to have small phrases or common phrases translated for easy reference while traveling in a foreign country. As a consequence, it would be advantageous to have a mobile application that could assist a traveler in the translation into a foreign language while traveling.

### SUMMARY OF THE INVENTION

The present invention relates to a system of language translation compromising: a personal electronic device; memory residing on the personal electronic device; a microprocessor residing on the personal electronic device; a microphone on the personal electronic device to receive audio speech; a speaker on the personal electronic device to transmit audio speech; and software residing in the memory, where the software enables recognition of speech received in the microphone in a first language, and enables the transmission of a second language through the audio speakers, where the second language reflects a translation of the first language message received in the microphone.

### BRIEF DESCRIPTION OF DRAWINGS

FIG. 1 depicts a system of language translation using a mobile application in accordance with the present invention.

### DETAILED DESCRIPTION

The present invention relates to a system for language translation that utilizes a mobile application on a portable electronic device. The present invention includes software that is implemented in a mobile application on a portable electronic device. In one particular embodiment, this portable electronic device may be a smartphone or a portable cell phone that stores software applications. The present invention may be utilized by using an audio input or microphone of a portable electronic device. The application recognizes the language that is spoken into the microphone of the portable electronic device and in turn translates the received speech into a second language and outputs the translation into text or an audio message in the second language.

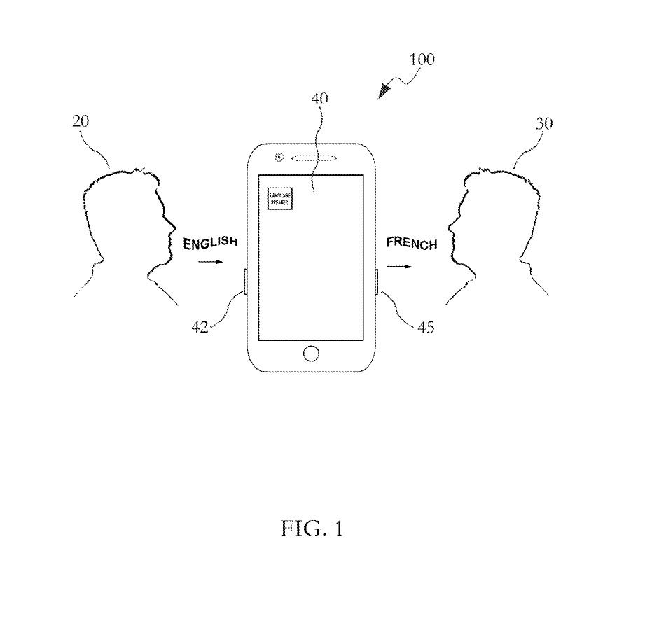

In reference to FIG. 1, an overall depiction of a system in accordance with the present invention is depicted. The system of the present invention includes a Portable Electronic Device 100. In one particular embodiment, the Portable Electronic Device 100 may include a smartphone. The Electronic Device 100 includes a Touchscreen 40 that allows the user to activate a software application residing on memory within the Electronic Device 100. The software application includes speech recognition features to recognize any speech into a Microphone 42 of the Electronic Device 100. The microphone receives a first language spoken by a User 20 shown in FIG. 1. This first language is recognized by the software and translated into a desired second language, which is output through a Speaker 45 on the Electronic Device 100. A second user then listens to the audio language emitted and receives the message translated into a second language.

The system according to the present invention operates with a portable electronic device that at least includes memory and a microprocessor capable of processing instructions related to software residing on the memory. The electronic device may further include an Interactive Touchscreen 40 as depicted in FIG. 1. The interactive touchscreen allows the user to activate the software and utilize the translation function as described above. The software may be pre-programmed to recognize a plurality of languages and as a consequence emit or translate the first received language into a second language over the audio speaker provided on the electronic device. The system according to the present invention enables the user to have a portable translation system readily available on a portable electronic device. The instant invention has been shown and described in what it considers to be the most practical and preferred embodiments. It is recognized, however, that departures may be made there from within the scope of the invention and that obvious modifications will occur to a person skilled in the art.

What is claimed:

1. A system of language translation compromising:
a personal electronic device;
memory residing on the personal electronic device;
a microprocessor residing on the personal electronic device;
a microphone on the personal electronic device to receive audio speech;
a speaker on the personal electronic device to transmit audio speech; and
software residing in the memory, where the software enables recognition of speech received in the microphone in a first language, and enables the transmission of a second language through the audio speakers, where the second language reflects a translation of the first language message received in the microphone.

2. The system of language translation according to claim 1, where said software is downloadable onto the electronic device via an Internet connection.

3. The system of language translation according to claim 1, where the software recognizes a first set of languages and enables the translation into a second set of languages wherein the recognized languages coincide with the translated languages.
